(19) United States
(12) Patent Application Publication
(10) Pub. No.: US 2022/0020080 A1
(43) Pub. Date: Jan. 20, 2022

(54) Data Entity Revisions for an Offline Database

(71) Applicant: Home Depot Product Authority, LLC, Atlanta, GA (US)

(72) Inventors: Hari Ramamurthy, Marietta, GA (US); Angie Brown, Atlanta, GA (US); Thomas Gamble, Atlanta, GA (US); Stephen Jacobs, Marietta, GA (US); David Rogers, Ellijay, GA (US)

(21) Appl. No.: 17/387,424

(22) Filed: Jul. 28, 2021

Related U.S. Application Data
(63) Continuation of application No. 15/062,081, filed on Mar. 5, 2016, now abandoned.

(51) Int. Cl. G06Q 30/06; G06Q 10/08

(52) U.S. Cl. CPC G06Q 30/0635; G06Q 10/087

(57) ABSTRACT

A method for processing user orders for products may include receiving an order for an order quantity of the product from a user computing device, determining that the order management system cannot communicate with the inventory management system to reserve the order quantity of the product, retrieving a last known inventory quantity of the product, retrieving an offline demand quantity for the product, transmitting a confirmation of the order to the user computing device when the sum of the order quantity and the offline demand quantity of the product is less than or equal to the last known inventory quantity of the product, and transmitting a denial of the order to the user computing device when the sum of the order quantity and the offline demand quantity of the product is greater than the last known inventory quantity of the product.

### CROSS-REFERENCE TO RELATED APPLICATION

This application is a continuation of U.S. application Ser. No. 15/062,081, filed Mar. 5, 2016, and is related to U.S. application Ser. No. 15/062,075, issued as U.S. Pat. No. 10,497,049, both of which applications are hereby incorporated by reference in their entireties.

### FIELD OF THE DISCLOSURE

This disclosure is generally directed to the processing of orders for products received through network-based channels, including determining the status of an inventory management system and processing orders received during different statuses of an inventory management system.

### BACKGROUND OF RELATED ART

A retailer may sell products and services through numerous sales channels, including in-store carry sales, website and mobile app sales, and in-store non-carry sales. Orders for website and mobile app sales and in-store non-carry sales are generally reserved by an inventory management system. When the inventory management system goes offline, there are two general approaches. The first approach is to confirm every order while the inventory management system is offline, then check for availability for the order after the inventory management system is back online and cancel confirmed orders as necessary. The second approach is to reject all orders while the inventory management system is offline.

### SUMMARY

An illustrative order management system for processing user orders for products may include a data storage subsystem configured to store last known inventory data and offline demand data. The system may further include an order processing subsystem configured to communicate with an inventory management system and configured to receive a last known inventory quantity of a product from the inventory management system and store the last known inventory quantity of the product in the last known inventory data. The order processing subsystem may be further configured to receive an order for an order quantity of the product from a user computing device, the order received over a network, determine that the order processing subsystem cannot communicate with the inventory management system to reserve the order quantity of the product, retrieve the last known inventory quantity of the product from the last known inventory data, retrieve an offline demand quantity for the product from the offline demand data, compare the sum of the order quantity and the offline demand quantity of the product with last known inventory quantity of the product, transmit a confirmation of the order to the user when the sum of the order quantity and the offline demand quantity of the product is less than or equal to the last known inventory quantity of the product, and transmit a denial of the order to the user when the sum of the order quantity and the offline demand quantity of the product is greater than the last known inventory quantity of the product.

An illustrative method for processing user orders for products may include receiving, by a computerized order management system, a last known inventory quantity for a product from an inventory management system and storing, by the computerized order management system, the last known inventory quantity in last known inventory data. The method may further include receiving, by the computerized order management system, an order for an order quantity of the product from a user computing device, the order received over a network, determining, by the computerized order management system, that the order management system cannot communicate with the inventory management system to reserve the order quantity of the product, retrieving, by the computerized order management system, the last known inventory quantity of the product from the last known inventory data, retrieving, by the computerized order management system, an offline demand quantity for the product from the offline demand data, and comparing, by the computerized order management system, the sum of the order quantity and the offline demand quantity of the product with the last known inventory quantity of the product. The method may further include transmitting, by the computerized order management system, a confirmation of the order to the user computing device when the sum of the order quantity and the offline demand quantity of the product is less than or equal to the last known inventory quantity of the product, and transmitting, by the computerized order management system, a denial of the order to the user computing device when the sum of the order quantity and the offline demand quantity of the product is greater than the last known inventory quantity of the product.

An illustrative order management system for processing user orders for products may include a data storage subsystem configured to store last known inventory data, offline demand data, and an order processing status, the order processing status being indicative of a state of an inventory management system and having a value of one of ONLINE, SYNCHRONIZING, or OFFLINE. The system may further include an order processing subsystem configured to communicate with the inventory management system and configured to receive a last known inventory quantity for a product from the inventory management system and store the last known inventory quantity in the last known inventory data. The order processing subsystem may be further configured to receive an order for an order quantity of the product from a user computing device, the order received over a network, retrieve the order processing status from the data storage subsystem. When the order processing status is OFFLINE, the order processing subsystem may be configured to retrieve the last known inventory quantity of the product from the last known inventory data, retrieve an offline demand quantity for the product from the offline demand data, compare the sum of the order quantity and the offline demand quantity of the product with the last known inventory quantity of the product, transmit a confirmation of the order to the user when the sum of the order quantity and the offline demand quantity of the product is less than or equal to the last known inventory quantity of the product, and transmit a denial of the order to the user when the sum of the order quantity and the offline demand quantity of the product is greater than the last known inventory quantity of the product.

### BRIEF DESCRIPTION OF THE DRAWINGS

FIG. 1 is a diagrammatic view of a user computing environment, according to some embodiments.

FIG. 2 is a block diagram view of an order placement and reservation system, according to some embodiments.

FIG. 3 is a sequence diagram illustrating a method of receiving and processing an order for a product with an inventory management system online, according to some embodiments.

FIG. 4 is a sequence diagram illustrating a method of receiving and processing an order for a product with an inventory management system offline or in a synchronization mode, according to some embodiments.

FIG. 5 is a table illustrating an order by a user for a plurality of products, according to some embodiments.

FIG. 6 is a table illustrating information that may be considered to determine how to process the illustrative order of FIG. 5 with the method of FIG. 4, according to some embodiments.

FIG. 7 is a sequence diagram illustrating a method of diagnosing and storing the status of an inventory management system, according to some embodiments.

FIG. 8 is a sequence diagram illustrating a method of synchronizing an inventory management system with orders received while the inventory management system was offline, according to some embodiments.

### DETAILED DESCRIPTION

The present disclosure includes systems and methods for receiving and processing user orders. Such orders may be for products or services from a retailer, wholesaler, or other source. The remainder of this disclosure will be made with reference to embodiments in which the user orders are for products sold by a single retailer, with the users being end customers or associates for brick-and-mortar locations of that retailer. Such disclosure is by way of example only.

The receiving and processing of user orders disclosed herein improves upon known methods and systems for receiving and processing user orders, particularly while the inventory management system is offline. The two general known methods for receiving and processing user orders while the inventory management system is offline both have drawbacks. The first method, confirming every order, then later cancelling orders as needed, may result in a large number of false positive order confirmations, resulting in displeased customers who thought they had successful orders later finding out that their orders were unsuccessful. The second method, rejecting all orders while the inventory management system is offline, may result in lost revenue for the retailer. In contrast, methods and systems according to the present disclosure may improve the retailer's ability to continue to generate revenue during inventory management system outages without excessively confirming orders for which it is not known if sufficient inventory is available. Accordingly, both the retailer's needs (for sales) and the user's needs (for order certainty) are addressed.

The systems and methods of the present disclosure provide a technology-based solution for improving the field of network-based order and inventory management systems, thus improving the Internet-centric problem of receiving and processing orders during an inventory management system outage. The system and methods of the present disclosure may improve the functionality of the retailer by improving system uptime and may also improve the inventory management system by providing an orderly method by which the inventory management system resynchronizes with orders placed while the inventory management system was offline, thereby improving the functionality of the inventory management system during the resynchronization period. Furthermore, the system and methods of the present disclosure may provide a single point in the flow of an order that may account for downtime of an inventory management system, so that each individual point in the order flow need not include its own independent solution.

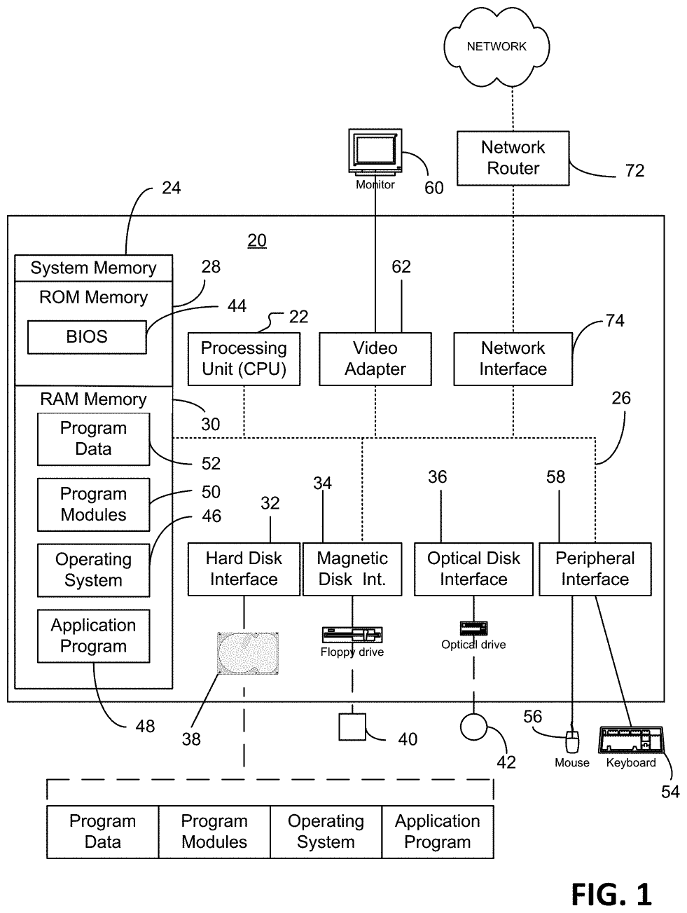

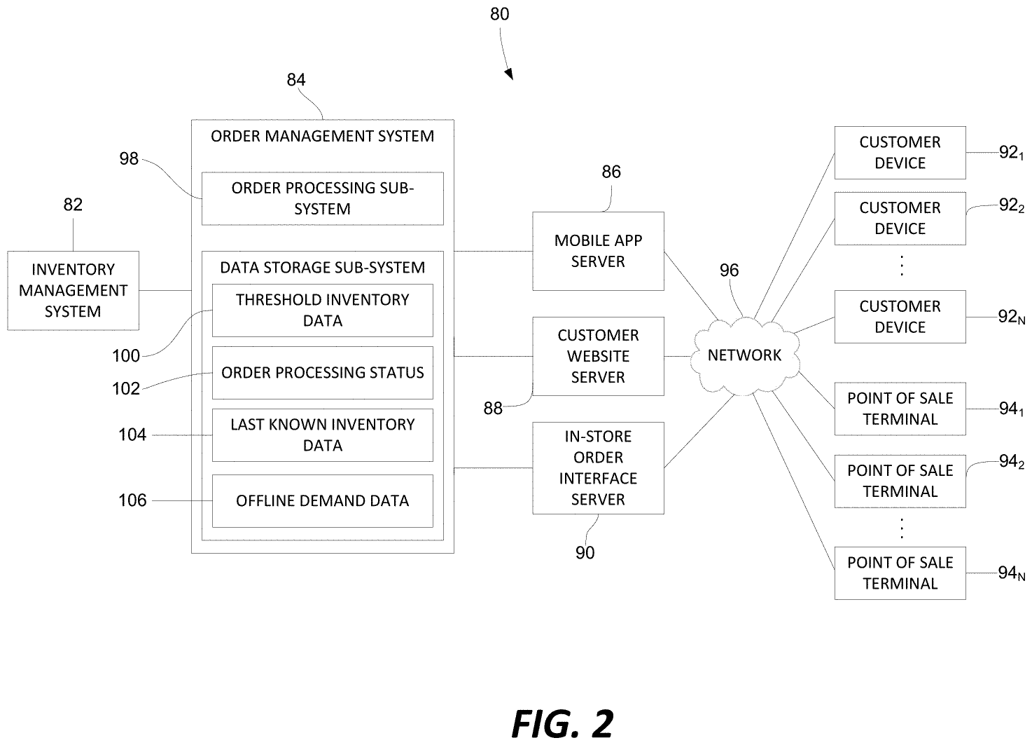

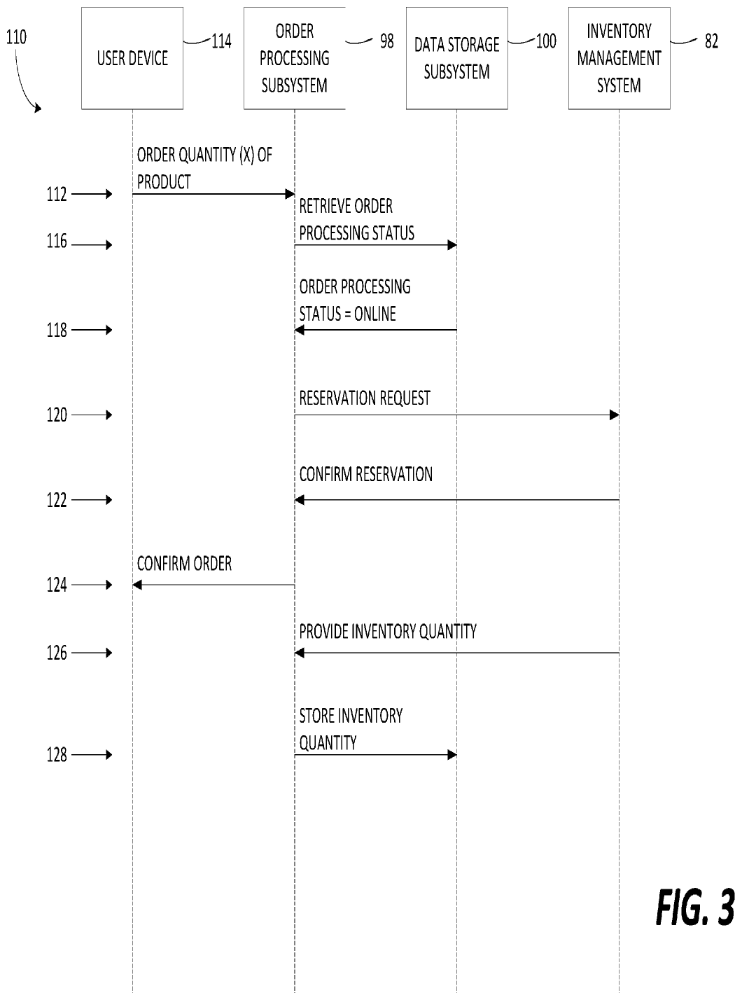

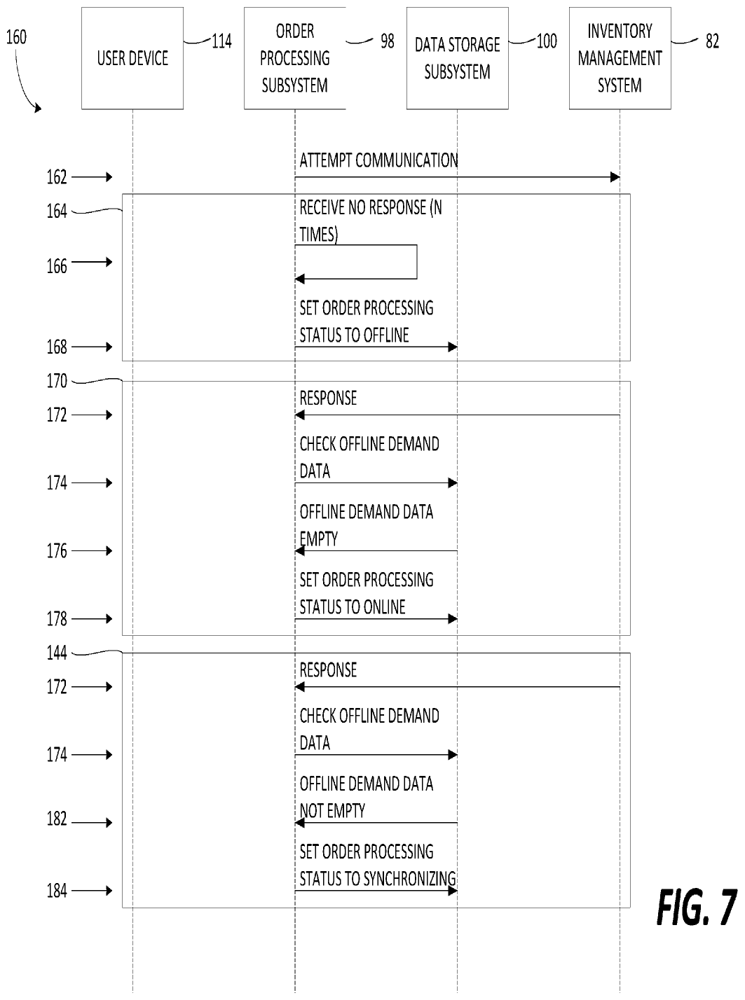

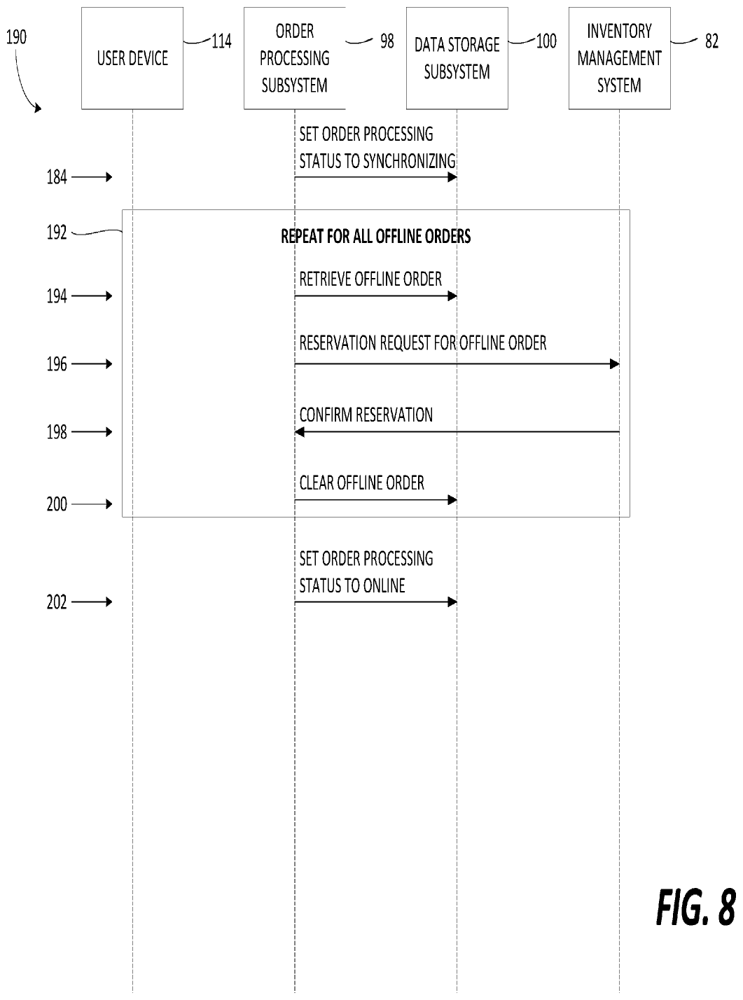

First, with respect to FIG. 1, a computing environment that may be used by a customer or retail associate will be described. Portions of the computing environment of FIG. 1 may also be deployed for an inventory management system and/or an order management system of the present disclosure. With respect to FIG. 2, an illustrative system for receiving and processing orders, including an inventory management system and an order management system, will be described. With respect to FIGS. 2 and 3, an illustrative method for receiving and processing user orders while the inventory management system is online will be described. With respect to FIGS. 2 and 4-6, an illustrative method for receiving and processing user orders while the inventory management system is offline or resynchronizing will be described. With respect to FIGS. 2 and 7, an illustrative method for diagnosing and storing the status of an inventory management system will be described. Finally, with respect to FIGS. 2 and 8, an illustrative method for resynchronizing an inventory management system will be described.

Reference will now be made in detail to the preferred embodiments of the invention, examples of which are illustrated in the accompanying drawings. FIG. 1 is a diagrammatic view of an illustrative computing system that includes a general purpose computing system environment 20, such as a desktop computer, laptop, smartphone, tablet, or any other such device having the ability to execute instructions, such as those stored within a non-transient, computer-readable medium. Furthermore, while described and illustrated in the context of a single computing system 20, those skilled in the art will also appreciate that the various tasks described hereinafter may be practiced in a distributed environment having multiple computing systems 20 linked via a local or wide-area network in which the executable instructions may be associated with and/or executed by one or more of multiple computing systems 20.

In its most basic configuration, computing system environment 20 typically includes at least one processing unit 22 and at least one memory 24, which may be linked via a bus 26. Depending on the exact configuration and type of computing system environment, memory 24 may be volatile (such as RAM 30), non-volatile (such as ROM 28, flash memory, etc.) or some combination of the two. Computing system environment 20 may have additional features and/or functionality. For example, computing system environment 20 may also include additional storage (removable and/or non-removable) including, but not limited to, magnetic or optical disks, tape drives and/or flash drives. Such additional memory devices may be made accessible to the computing system environment 20 by means of, for example, a hard disk drive interface 32, a magnetic disk drive interface 34, and/or an optical disk drive interface 36. As will be understood, these devices, which would be linked to the system bus 26, respectively, allow for reading from and writing to a hard disk 38, reading from or writing to a removable magnetic disk 40, and/or for reading from or writing to a removable optical disk 42, such as a CD/DVD ROM or other optical media. The drive interfaces and their associated computer-readable media allow for the nonvolatile storage of computer readable instructions, data structures, program modules and other data for the computing system environment 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 20.

A number of program modules may be stored in one or more of the memory/media devices. For example, a basic input/output system (BIOS) 44, containing the basic routines that help to transfer information between elements within the computing system environment 20, such as during start-up, may be stored in ROM 28. Similarly, RAM 30, hard drive 38, and/or peripheral memory devices may be used to store computer executable instructions comprising an operating system 46, one or more applications programs 48 (such as a Web browser, retailer's mobile app, and/or retailer's point-of-sale checkout and ordering program), other program modules 50, and/or program data 52. Still further, computer-executable instructions may be downloaded to the computing environment 20 as needed, for example, via a network connection.

An end-user, e.g., a customer, retail associate, and the like, may enter commands and information into the computing system environment 20 through input devices such as a keyboard 54 and/or a pointing device 56. While not illustrated, other input devices may include a microphone, a joystick, a game pad, a scanner, etc. These and other input devices would typically be connected to the processing unit 22 by means of a peripheral interface 58 which, in turn, would be coupled to bus 26. Input devices may be directly or indirectly connected to processor 22 via interfaces such as, for example, a parallel port, game port, firewire, or a universal serial bus (USB). To view information from the computing system environment 20, a monitor 60 or other type of display device may also be connected to bus 26 via an interface, such as via video adapter 62. In addition to the monitor 60, the computing system environment 20 may also include other peripheral output devices, not shown, such as speakers and printers.

The computing system environment 20 may also utilize logical connections to one or more computing system environments. Communications between the computing system environment 20 and the remote computing system environment may be exchanged via a further processing device, such a network router 72, that is responsible for network routing. Communications with the network router 72 may be performed via a network interface component 74. Thus, within such a networked environment, e.g., the Internet, World Wide Web, LAN, or other like type of wired or wireless network, it will be appreciated that program modules depicted relative to the computing system environment 20, or portions thereof, may be stored in the memory storage device(s) of the computing system environment 20.

FIG. 2 is a block diagram view of an illustrative system 80 for order placement, reception, and processing. The system 80 may include an inventory management system 82, an order management system 84, a mobile app server 86, a customer website server 88, an in-store interface server 90, a plurality of customer devices 92₁, 92₂, . . . , 92_{N} (which may be referred to individually as a customer device 92 or collectively as customer devices 92), and a plurality of point-of-sale terminals 94₁, 94₂, . . . , 94_{N} (which may be referred to individually as a point-of-sale terminal 94 or collectively as point-of-sale terminals 94).

The customer devices 92 and the point-of-sale terminals 94 are various embodiments of computing environments such as the computing environment 20 illustrated in and described with respect to FIG. 1. For example, the customer devices 92₁, 92₂, . . . , 92_{N} may be personal computers, tablets, mobile phones, and the like, capable of placing orders through a website or application. The point-of-sale terminals 94₁, 94₂, . . . , 94_{N} may be computing terminals in brick-and-mortar retail stores, in an embodiment. The point-of-sale terminals 94 may be used, for example, by a retail associate to place an order on behalf of a customer at the store for a product that is not in that particular store, does not have sufficient inventory in that store, etc. (sometimes referred to as a “non-carry” order), in addition to other known point-of-sale functions.

The mobile app server 86, the customer website server 88, and the in-store order interface server 90 may be configured to be accessed by the customer devices 92 and/or point-of-sale terminals 94 over a network 96 (e.g., the Internet) and to provide interfaces through which orders for products may be placed on the customer devices 92 and point-of-sale terminals 94. For example, in an embodiment: the mobile app server 86 hosts and provides a mobile app interface and/or mobile website interface through which a user mobile device (e.g., mobile phone or tablet, which may be customer device 92₁, in an embodiment) may place an order; the customer website server 88 hosts and provides a website interface through which a user personal computer (which may be customer device 92₂, in an embodiment) may place an order; and the in-store order interface server 90 provides an interface through which point-of-sale terminals 94 may place orders on behalf of customers.

The servers 86, 88, 90 may provide the entirety of an interface, or may work in conjunction with an application or client stored and executing on a user device 92 or point-of-sale terminal 94 to provide that interface. For example, in an embodiment, one or more of the servers 86, 88, 90 may cooperate and interact with a web browser, mobile app, point-of-sale checkout software, and/or other software to provide the full interface.

As part of providing the order interface, the servers 86, 88, 90 may cause order confirmations (or rejections) to appear in those interfaces, in an embodiment. The servers 86, 88, 90 may cause an order confirmation (or rejection) to appear in the interface responsive to instructions from the order management system 84 or responsive to a transmission of such an order confirmation (or rejection) from the order management system 84.

In various embodiments, the inventory management system 82 may manage the inventory of a retailer. The inventory management system 82 may be an inventory management module of a Sterling distributed order management system, commercially available from IBM, or other appropriate inventory management system. The inventory management system 82 stores the location of each and every item of stock of the retailer, including retail locations, warehouses, and the like, reserves items of stock to account for unfulfilled orders, initiates and instructs order fulfillment, and initiates and instructs supply replenishment, in an embodiment.

The inventory management system 82 may periodically go offline as a result of a network outage, hardware failure, planned maintenance, etc. When offline, the inventory management system may be unable to communicate with the order management system to confirm orders received by the order management system from customer devices 92 and point of sale terminals 94.

The order management system 84 may be generally configured to determine and store the status of the inventory management system 82 and to receive and process orders so as to present generally the same or a similar ordering experience to users regardless of the status of the inventory management system 82, i.e., the same user experience whether the inventory management system 82 is online or offline. The order management system may be configured to, in an embodiment, perform an order reservation in conjunction with the inventory management system 82 when the inventory management system 82 is online, perform unofficial order reservations when the inventory management system 82 is offline or resynchronizing after coming back online, and assist the inventory management system 82 in resynchronizing after coming back online.

The order management system 84 may be a computerized environment that may include an order processing sub-system 98 and a data storage sub-system 100, in various embodiments. The order management system 84, or some or all components of the order management system, comprises some or all of the components of the computing environment 20 of FIG. 1, scaled for the operations disclosed herein, in an embodiment. The order management system 84 may be configured for network-based communication with the inventory management system 82 and the servers 86, 88, 90, in an embodiment. In addition, the components of the order management system 84—i.e., the order processing sub-system 98 and the data storage sub-system 100—are configured for network-based communications with each other, in an embodiment.

The data storage sub-system 100 stores a number of categories of data useful for carrying out one or more methods for receiving and processing user orders, such as the methods of this disclosure. In an embodiment, the data storage sub-system 100 stores an order processing status 102, last known inventory data 104, and offline demand data 106. The data storage sub-system 100 may be, for example, a no-SQL Apache database system or other open source or commercial no-SQL solution, in an embodiment.

The representations of the order processing status 102, last known inventory data 104, and offline demand data 106 and the storage of that data illustrated and described in this disclosure are illustrative only, and changes may be made and remain within the spirit and scope of this disclosure. For example, although shown as separate data, the contents of two or more of the order processing status 102, last known inventory data 104, and offline demand data 106 may be stored in a single file, directory, database, etc. In addition, although shown separately, the order processing sub-system and the data storage sub-system, or portions thereof, may be implemented on a single sub-system. Furthermore, though shown as a part of the data storage subsystem 100, the order processing status 102 may additionally or alternatively be stored or maintained by the order processing subsystem 98.

The order processing status 102 is a value indicative of a status of the inventory management system 82 that informs how the order management system processes orders, in an embodiment. The order processing status 102 may be, for example, one of ONLINE, OFFLINE, or SYNCHRONIZING. A status of ONLINE may indicate that the inventory management system 82 is online, that is, the order management system 84, or component thereof, can communicate with the inventory management system 82 to reserve a product responsive to orders, in an embodiment. A status of OFFLINE may indicate the opposite—that the order management system 84, or component thereof, cannot communicate with the inventory management system 82 to reserve a product responsive to orders, in an embodiment. A status of SYNCHRONIZING may indicate that the inventory management system 82 is available for communication with the order management system, but is in the process of resynchronizing with orders made while the inventory management system 82 was offline.

The remainder of this disclosure will be with respect to embodiments in which the order processing status is one of ONLINE, OFFLINE, or SYNCHRONIZING. It should be understood, however, that such order processing statuses are by way of example only, and different or additional statuses may be used.

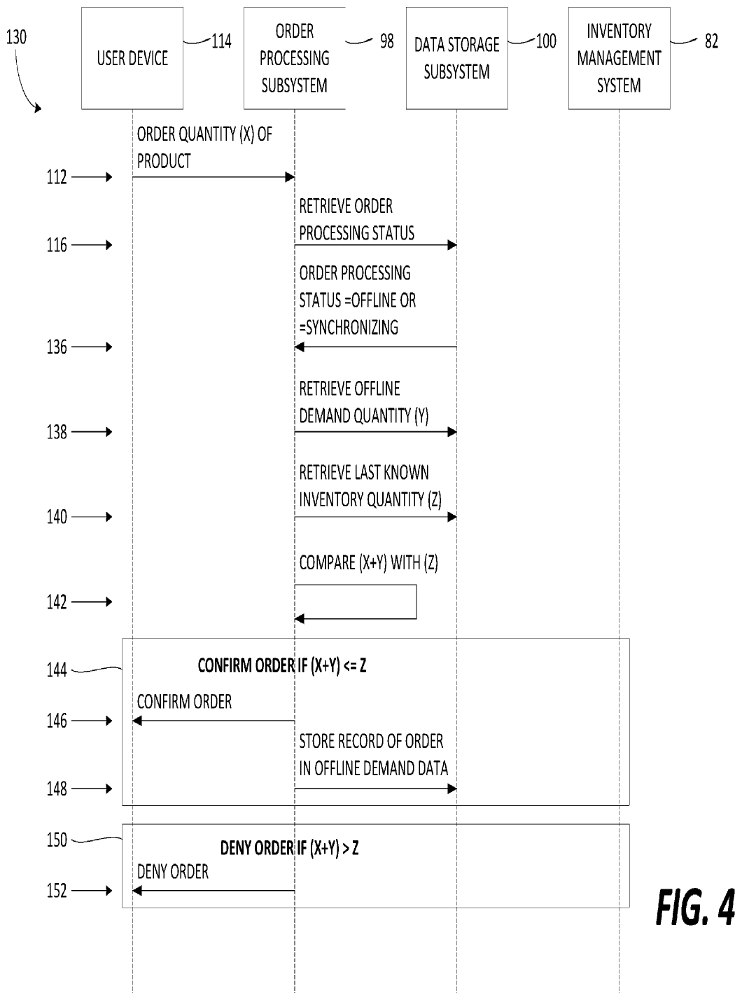

The order processing status 102 may be set by the order processing subsystem 98 and utilized by the order processing subsystem 98 to inform how orders received from customer devices 92 and point of sale terminals 94 are processed, in an embodiment. For example, when the order processing status 102 is ONLINE, the order management system may perform a traditional synchronous reservation, or a modified version of such a reservation (e.g., as illustrated in and described below with respect to FIG. 3), in conjunction with the inventory management system 82, in an embodiment. In another embodiment, when the order processing status 102 is ONLINE, the order management system may process the order according to a method or technique disclosed in co-pending application entitled “Optimistic Product Order Reservation System and Method,” incorporated above. When the order processing status 102 in OFFLINE or SYNCHRONIZING, the order management system may process the order according to one or more processes, methods, or techniques of this disclosure, such as the method that is illustrated in and will be described with respect to FIGS. 4-6, in an embodiment. Generally, such processes, methods, and techniques may include an unofficial order confirmation by the order management system, independent of the inventory management system 82, that is later confirmed by the inventory management system 82 when the inventory management system 82 is back online.

With continued reference to FIG. 2, the last known inventory data 104 may include a listing of the last known inventory (i.e., last known quantity in stock) for a plurality of products carried by the retailer, in an embodiment. For example, in an embodiment, the last known inventory data 104 stores the last known inventory for thousands, tens of thousands, or more different products.

The last known inventory data may be separate from the inventory management system 82, in an embodiment. The last known inventory data may include significantly less information, and for a narrower purpose, than the inventory management system 82, and therefore may provide significantly faster access to the information stored. The “knowledge” stored in the last known inventory data may be from the point of view of the order management system 84, not the point of view of the inventory management system 82, in an embodiment. However, the last known inventory data may be updated according to data obtained from the inventory management system 82, or in conjunction with data exchanged with the inventory management system 82, as will be set forth in further detail later in this disclosure.

The offline demand data 106 may include records of orders received by the order management system 84 while the inventory management system 82 is offline or resynchronizing after coming back online, in an embodiment. As will be described in further detail in this disclosure, the order processing subsystem 98 may be configured to store records of orders in the offline demand data 106 such as, for example, when those orders are received while the inventory management system 82 is offline or resynchronizing after coming back online. The records of orders stored in the offline demand data 106 may include the same or similar information as records of orders stored in the inventory management system 82, in an embodiment.

The offline demand data 106 may include an offline demand quantity for one or more products, in an embodiment. The offline demand quantity may be inherent in orders stored in the offline demand data 106, or may be computed based on those orders and stored separately from the order records in the offline demand data 106.

The order processing sub-system 98 may be a computerized processing system that may be configured to perform one or more tasks, steps, methods, etc. to facilitate the receipt and processing of orders received from customer devices 92 and point-of-sale terminals 94, in an embodiment. The order processing sub-system 98 comprises some or all of the components of the computing environment 20 of FIG. 1, scaled for the operations disclosed herein, in an embodiment.

The order processing sub-system 98 may be configured to perform one or more methods for receiving and processing orders in conjunction with the data storage sub-system 100 and the inventory management system 82, in an embodiment. FIG. 3 is a sequence diagram illustrating one such method, an illustrative method 110 of receiving and processing an order for a product with the inventory management system 82 online. Many of the steps of the method 110, and of other methods of this disclosure, will be described as performed by the order processing sub-system 98. Accordingly, those steps may also be considered to be performed by the order management system 84.

Referring to FIGS. 2 and 3, the method 110 may include step 112 in which a user device 114 transmits an order for an order quantity of a product to the order processing subsystem 98. The order quantity is referred to in FIG. 3 and other figures of this disclosure as value “X.” The user device 114 may be, for example, a customer device 92 or a point-of-sale terminal 94.

Though not illustrated in FIG. 3, the transmission of the order from the user device 114 to the order processing subsystem 98 may be through a server 86, 88, 90 and network 96. For example, the order may be placed through a user interface provided in whole or in part by a server 86, 88, 90. Other communications between the order processing subsystem 98 and user device 114 discussed in this disclosure may also be through a server 86, 88, 90 and network 96, in an embodiment. For example, in an embodiment, the order may be received by the order processing subsystem 98 through an interface provided by a server 86, 88, 90.

The method 110 may further include step 116 in which the order processing subsystem 98 retrieves an order processing status 102. As noted above, the value of the order processing status 102 may be, but is not limited to, ONLINE, SYNCHRONIZING, or OFFLINE, in an embodiment.

The method 110 may further include step 118 in which the order processing subsystem 98 receives an order processing status 102 of ONLINE from the data storage subsystem 100. The remainder of the method 110 addresses the processing of orders when the order processing status 102 is ONLINE. An illustrative method for processing orders when the order processing status 102 is OFFLINE or SYNCHRONIZING is illustrated in and will be described with respect to FIG. 4.

Certain retrieval of data, such as step 116, is illustrated herein with a subsequent return of data shown as a separate step, i.e., step 118. It should be understood that one or more of the retrievals of data of the method 110 and other methods of this disclosure, as would be appreciated by a person of skill in the art, involve a request for data and a return of data. The illustration or omission of the return of retrieved data in a figure and accompanying description is for convenience of illustration and description only.

With continued reference to FIG. 3, the method 110 may further include step 120 in which the order processing subsystem 98 transmits a reservation request to the inventory management system 82, step 122 in which the inventory management system 82 transmits a reservation confirmation to the order processing subsystem 98, and step 124 in which the order processing subsystem 98 transmits an order confirmation to the user device 114. The reservation steps 120, 122, 124 may be performed in sequence, as illustrated, or may be performed according to the teachings of co-pending application entitled “Optimistic Product Order Reservation System and Method,” incorporated above, or may be performed in some other order or fashion.

Although the method 110 only illustrates a situation in which the order is confirmed, the order may be rejected in other situations. For example, after receiving the reservation request from the order processing system at step 120, the inventory management system 82 may determine that the order is for more units of the ordered product than are available in stock. Accordingly, in such a scenario, the inventory management system 82 may transmit a reservation rejection to the order processing subsystem 98, and the order processing subsystem 98 may transmit an order rejection to the user device 114.

With continued reference to FIG. 3, the method 110 may further include step 126 in which the inventory management system 82 provides an inventory quantity of one or more products, such as the product ordered in step 112 and/or other or additional products, to the order processing subsystem 98. The inventory quantity provided by the inventory management system 82 may be the amount of stock of the product available for purchase at the time the step is performed, in an embodiment.

The method 110 may further include step 128 in which the order processing subsystem 98 stores the inventory quantity or quantities provided in step 126 in the data storage subsystem 100. For example, the inventory quantity may be stored in the last known inventory data 104.

The provision and storage of an inventory quantity in steps 126 and 128 may be performed in conjunction with reservation of a user order, as illustrated in and described with respect to FIG. 3, in embodiments. Additionally or alternatively, the provision and storage of inventory quantities in steps 126 and 128 may be performed periodically so as to periodically cache last known inventory quantities of various products in the last known inventory data 104.

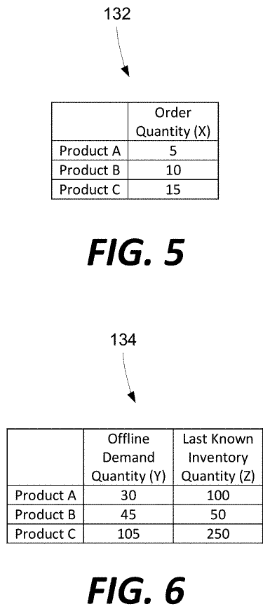

FIG. 4 is a sequence diagram illustrating an illustrative method 130 of processing user orders when the order processing status 102 is OFFLINE or SYNCHRONIZING. FIG. 5 is a table 132 that illustrates an illustrative order, and FIG. 6 is a table 134 that illustrates illustrative data that may be considered in performing the method 130 of FIG. 4 on the order of FIG. 5. The method 130 will now be described with reference to FIGS. 2 and 4-6.

The method 130 may include two steps previously described in conjunction with method 110. In step 112, the order processing subsystem 98 may receive an order for an order quantity X of a product from a user device. For the example order of FIG. 5, the order processing subsystem 98 would receive an order for five (5) units of Product A, ten (10) units of Product B, and fifteen (15) units of Product C, in an embodiment. In step 116, the order processing subsystem 98 may retrieve an order processing status 102 from the data storage subsystem 100.

The method 130 may further include step 136 in which the data processing subsystem returns an order processing status 102 of OFFLINE or SYNCHRONIZING. When the order processing status 102 is OFFLINE or SYNCHRONIZING, the order processing subsystem 98 may process the order generally independent of the inventory management system 82 (e.g., using local resources instead), in an embodiment, as detailed in the further steps of the method described below.

The method 130 may further include step 138 in which the order processing subsystem 98 retrieves an offline demand quantity of the product from the data storage subsystem 100 (i.e., from the offline demand data 106). The offline demand quantity is designated in FIGS. 4 and 6 as value “Y.” For the example data of FIG. 6, the order processing subsystem 98 may retrieve an offline demand quantity of thirty (30) units for Product A, forty-five (45) units for Product B, and one hundred and five (105) units for Product C.

To retrieve the offline demand quantity of a particular product, the order processing subsystem 98 may retrieve a single value that is stored in the offline demand data 106, in an embodiment, as generally illustrated in the illustrative data of FIG. 6. Alternatively, the order processing subsystem 98 may sort through records of orders stored in the offline demand data 106 at the time an offline demand quantity is needed in order to calculate an offline demand quantity for a given product. For example, if the offline demand data 106 may include records of two hundred (200) total orders, with three (3) of those orders being for Product A, in which two units, two units, and one unit of Product A were respectively ordered, the order processing subsystem 98 may sort through those orders and add up the quantities of the orders to arrive at an offline demand quantity of five (5) units.

The values in the tables of FIGS. 5 and 6 are illustrative in nature only and are intended to help illustrate the method 130. Neither the exact numbers themselves nor the general scope and scale of those numbers should be considered limiting except as expressly set forth in the claims. In particular, although an illustrative order for three products is generally disclosed is FIG. 5 and illustrative information for those three products is disclosed in FIG. 6, an order may have any number of products, and the information stored in the data storage subsystem 100 (e.g., in the offline demand data 106 and the last known inventory data 104) may include data for any number of products.

The method 130 may further include step 140 in which the order processing subsystem 98 retrieves a last known inventory quantity from the data storage subsystem 100 (i.e., from the last known inventory data 104). The last known inventory quantity is designated as value “Z” in FIGS. 4 and 6. For the example data of FIG. 6, the order processing subsystem 98 may retrieve last known inventory quantities of one hundred (100), fifty (50), and two hundred and fifty (250) for Products A, B, and C, respectively.

The method 130 may further include step 142 in which the order processing subsystem 98 compares, for each product in the order, the sum of the order quantity (X) and the offline demand quantity (Y) with the last known inventory quantity (Z). For the illustrative order and information of FIGS. 5 and 6, the order processing subsystem 98 may compare (5+30=35) with (100) for Product A, compare (10+45=55) with (50) for Product B, and (15+105=120) with (250) for Product C.

Although the comparison step 142 is described in terms of an embodiment in which the order processing subsystem 98 compares (X+Y) with (Z), it should be understood that any equivalent may be made, and that such equivalent mathematical comparisons are equivalent for the purpose of the method. For example, instead of comparing (X+Y) with (Z), the order processing subsystem 98 may compare (X) with (Z−Y), or may compare (Y) with (Z−X), and so on.

The outcome of the comparison at step 142 informs the response of the order processing subsystem 98 to the user device 114, in an embodiment. For example, if the sum of the order quantity and the offline demand quantity is less than or equal to the last known inventory quantity (thereby indicating that stock to fulfill the order is believed to be available), the method may advance to step 144 in which the order is confirmed as to that product. In the order confirmation step 144, the method may include a sub-step 146 in which the order processing subsystem 98 transmits an order confirmation to the user device 114 and a sub-step 148 in which the order processing subsystem 98 stores a record of the confirmed order in the offline demand data 106 in the data storage subsystem 100. For the illustrative order and data of FIGS. 5 and 6, the order may be confirmed as to Product A (because 5+30=35<100) and Product C (because 15+105=120<250).

Step 144 is indicated in FIG. 4 by a box surrounding substeps 146, 148. In the sequence diagrams of this disclosure. In FIG. 4 and later sequence diagrams of this disclosure (i.e., FIGS. 7 and 8), boxes surrounding steps or substeps are used to designate conditional or alternative steps or scenarios. The conditions under which the steps or substeps within those boxes may be executed are indicated in the figure itself and/or in the text of this disclosure.

Alternatively, in an embodiment, if the sum of the order quantity (X) and the offline demand quantity (Y) is greater than the last known inventory quantity (Z), the method 130 may advance to step 150 in which the order is denied as to that product. In the order denial step 150, the method 130 may include a sub-step 152 in which the order processing subsystem 98 transmits an order denial to the user device 114. For the illustrative order and data of FIGS. 5 and 6, the order may be denied as to Product B (because 10+45=55>50).

The illustrative method 130 of FIG. 4 may be performed independent of the inventory management system 82 and, therefore, may be applied when the inventory management system 82 is offline or resynchronizing after coming back online. As a result, execution of the method 130 may improve uptime of the ordering system of a retailer, improving the user experience and increasing the retailer's revenue.

As described above with respect to FIGS. 3 and 4, the order processing subsystem 98 may utilize an order processing status 102 to determine how to process incoming orders. FIG. 5 is a sequence diagram illustrating an illustrative method 160 of determining an order processing status 102.

The method 160 may include step 162 in which the order processing subsystem 98 attempts communication with the inventory management system 82. This communication may be a reservation request (e.g., as discussed in conjunction with step 120 in the method 110 of FIG. 3), may be a periodic communication specifically for the purpose of assessing communications between the order processing subsystem 98 and the inventory management system 82, or may be some other communication.

The method 160 may further include a first scenario 164 including step 166 in which the order processing subsystem 98 receives no response from the inventory management system 82 to a number N of attempted communications. That number N may be set as desired by an operator of the system according to, for example, how quickly the operator wants the order processing status set to OFFLINE responsive to communication failures. The first scenario 164 may further include step 168 in which the order processing subsystem 98 sets the order processing status 102 to OFFLINE.

The method may further include a second scenario 170 including step 172 in which the order processing subsystem 98 receives a response from the inventory management system 82. The second scenario 170 may further include step 174 in which the order processing subsystem 98 checks the offline demand data 106 stored in the data storage subsystem 100. The order processing subsystem 98 may check the offline demand data 106 to determine whether any order records are in the offline demand data 106 that have not been synchronized with the inventory management system 82, in an embodiment. The second scenario 170 may further include step 176 in which the order processing subsystem 98 determines that the offline demand data 106 is empty, i.e., does not include records of any orders that have not yet been synchronized with the inventory management system 82. The second scenario 170 may further include step 178 in which the order processing subsystem 98 sets the order processing status 102 to ONLINE.

The method 160 may further include a third scenario 180 including step 172 in which the order processing subsystem 98 receives a response from the inventory management system 82. The third scenario 180 may further include step 174 in which the order processing subsystem 98 checks the offline demand data 106 stored in the data storage subsystem 100. The third scenario 180 may further include step 182 in which the order processing subsystem 98 determines that the offline demand data 106 is not empty, i.e., does include records of one or more orders that have not been synchronized with the inventory management system 82. The third scenario 180 may further include step 184 in which the order processing subsystem 98 sets the order processing status 102 to SYNCHRONIZING.

The second and third scenarios 170, 180 of the method 160 generally result in the order processing status 102 being set to SYNCHRONIZING when the inventory management system 82 comes back online from being offline and remaining in the SYNCHRONIZING state (via the second scenario 170) for as long as the inventory management system 82 is resynchronizing with orders placed while it was offline. An illustrative method for resynchronizing the inventory management system 82 with offline orders will be disclosed below with respect to FIG. 8. Once the resynchronizing process is complete, the method may enter the third scenario 180, and the order processing status 102 may return to ONLINE, in an embodiment.

FIG. 8 is a sequence diagram illustrating an illustrative method 190 of synchronizing an inventory management system 82 with orders received while the inventory management system 82 was offline. The method 190 may include step 184 in which the order processing subsystem 98 sets the order processing status 102 to SYNCHRONIZING. Before this step 184, for the purposes of explaining the method 190, it is assumed that the order processing status 102 was OFFLINE and, while the order processing status 102 was OFFLINE, a plurality of orders were placed, records of which were stored in the offline demand data 106 of the order processing subsystem 98.

The method 190 may further include a series of steps (enclosed within box 192 in FIG. 8) that may be repeated sequentially for each of the orders having records in the offline demand data 106, in an embodiment. A first step 194 may include the order processing subsystem 98 retrieving an offline order from the offline demand data 106 in the data storage subsystem 100. A further step 196 may include the order processing subsystem 98 transmitting a reservation request for the retrieved offline order to the inventory management system 82. In a further step 198 of the method 190, the inventory management system 82 may transmit a reservation confirmation for the order to the order processing subsystem 98. The method 190 may further include step 200 that may include the order processing subsystem 98 clearing the offline order from the offline demand data 106. Clearing the record of the order from the offline demand data 106 may involve causing the record to be erased from the offline demand data 106, or may involve an indication being placed in the offline demand data 106 that the order was synchronized with the inventory management system 82, in embodiments.

The steps 194, 196, 198, 200 may be repeated for each non-cleared order record stored in the offline demand data 106, in an embodiment such that those orders are sequentially transmitted to the inventory management system and sequentially cleared from the offline demand data. After performing the steps 194, 196, 198, 200 to clear all order records in the offline demand data 106, the method 190 may further include step 202 in which the order processing subsystem 98 sets the order processing status 102 to ONLINE.

FIGS. 3, 4, 7, and 8 illustrates example steps utilized by various embodiments of the present technology and may include processes that, in various embodiments, are carried out by a processor under the control of computer-readable and computer-executable instructions. The computer-readable and computer-executable instructions may reside, for example, in non-transient data storage features, such as storage devices 38, 40 and 42 of FIG. 1. Although specific operations are disclosed in FIGS. 3, 4, 7, and 8 such operations serve as examples. That is, embodiments are well suited to performing various other operations or variations of the operations recited in FIGS. 3, 4, 7, and 8. It is appreciated that the operations shown in FIGS. 3, 4, 7, and 8 may be performed in an order different than presented, and that not all of the operations in FIGS. 3, 4, 7, and 8 may need to be performed. Where helpful for the purposes of illustration, and not for limitation, FIGS. 3, 4, 7, and 8 will, as noted above, be described with reference to the other figures, which illustrate hypothetical situations in which embodiments may be implemented.

The illustrative methods 160, 190 of FIGS. 7 and 8 may be performed at the same time as each other and/or at the same time as one of the methods 110, 130 of FIG. 3 or FIG. 4, or a portion of one of those methods, in embodiments. For example, the method 160 of FIG. 7 may be performed continuously by the data storage subsystem to maintain an accurate order processing status 102, which may be utilized in the methods 110, 130 of FIGS. 3 and 4. The method 190 of FIG. 8 may be performed when the order processing status 102 is switched to SYNCHRONIZING, in an embodiment. As a result, the method 190 of FIG. 8 may be executed in parallel with the method 130 of FIG. 4, in an embodiment, such that orders are processed according to the method 130 of FIG. 4 with the order processing status 102 set to SYNCHRONIZING while the order records are cleared from the offline demand data 106 according to the method 190 of FIG. 8, in an embodiment. In such an embodiment, an order processed according to the method 130 of FIG. 4 while the order processing status 102 is set to SYNCHRONIZING may be added to the offline demand data 106 and later cleared through the method 190 of FIG. 8.

The teachings of this disclosure may improve a retailer's network-based ordering systems by improving uptime of the system—i.e., improving the amount of time that the system can take orders and generate revenue—while reducing the number of false positive order confirmations by processing orders while the inventory management system 82 is offline or resynchronizing based on cached inventory data and offline demand data 106. The teachings of this disclosure may further improve uptime on any existing inventory management system without expensive hardware upgrades or considerable software rewrites, particularly when implementing a package solution.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

1-20. (canceled)

21. A system for processing user requests to modify data in a database, the system comprising:
a data storage subsystem configured to store last known database values and offline incremental revision data; and
a revision processing subsystem configured to communicate with a database system over a first network connection and configured to:
receive, over the first network connection, a last known value of a data entity from the database system;
store the last known value of the data entity in the last known database values;
after receiving the last known value of the data entity from the database system, transmit one or more further communications to the database system over the first network connection;
receive no response from the database system to a predetermined number of the one or more further communications;
receive an incremental revision to the data entity from a user computing device, the incremental revision to the data entity received over a second network connection; and
based on the receiving no response to the predetermined number of the one or more further communications, determine that the revision processing subsystem cannot communicate with the database system to perform the incremental revision to the data entity and, in response:
retrieve the last known value of the data entity from the last known database values;
retrieve an aggregate offline incremental revision value of the data entity from the offline incremental revision data;
compare a sum of the incremental revision and the aggregate offline incremental revision value with the last known value of the data entity;
transmit a confirmation of the incremental revision to the user computing device when the sum of the incremental revision and the aggregate offline incremental revision value is less than or equal to the last known value of the data entity; and
transmit a denial of the incremental revision to the user computing device when the sum of the incremental revision and the aggregate offline incremental revision value is greater than the last known value of the data entity.

22. The system of claim 21, wherein the offline incremental revision data comprises one or more records of incremental revisions received by the revision processing subsystem while the database system is unavailable to confirm the incremental revisions, wherein the revision processing subsystem is further configured to:
after transmitting the confirmation of the incremental revision, store a record of the incremental revision in the offline incremental revision data.

23. The system of claim 22, wherein the revision processing subsystem is further configured to:
after storing the record of the incremental revision in the offline incremental revision data, determine that the revision processing subsystem can communicate with the database system;
transmit the record of the incremental revision to the database system for the data entity to be revised in the database system; and
clear the record of the incremental revision from the offline incremental revision data.

24. The system of claim 23, wherein the record of the incremental revision is one of two or more incremental revision records stored in the offline incremental revision data, wherein the revision processing subsystem is further configured to:
transmit the incremental revisions of the two or more incremental revision records sequentially to the database system; and
clear the two or more incremental revision records sequentially from the offline incremental revision data.

25. The system of claim 24, wherein the incremental revision is a first incremental revision of a first data entity from a first user computing device, wherein the revision processing subsystem is further configured to:
receive a second incremental revision of a second data entity from a second user computing device, the second incremental revision received over a network;
determine that the revision processing subsystem can communicate with the database system to revise the second data entity;
determine that the offline incremental revision data includes records of one or more incremental revisions;
retrieve the last known value of the second data entity from the last known database values;
retrieve an offline incremental revision value for the second data entity from the offline incremental revision data;
compare a sum of the second incremental revision and the offline incremental revision value for the second data entity with the last known value of the second data entity;
transmit a confirmation of the second incremental revision to the second user when the sum of the second incremental revision and the offline incremental revision value for the second data entity is less than or equal to the last known value of the second data entity; and
transmit a denial of the second incremental revision to the second user when the sum of the second incremental revision and the offline incremental revision value for the second data entity is greater than the last known value of the second data entity.

26. The system of claim 23, wherein the incremental revision is a first incremental revision of a first data entity received from a first user computing device, wherein the revision processing subsystem is further configured to:
receive a second incremental revision of a second data entity from a second user computing device, the second incremental revision received over a network;
determine that the revision processing subsystem can communicate with the database system to revise the second data entity;
determine that the offline incremental revision data does not include records of any incremental revisions;
transmit a request to the database system to revise the second data entity according to the second incremental revision;
receive a confirmation from the database system that the second data entity is revised according to the second incremental revision; and
transmit a confirmation of the second incremental revision to the second user computing device.

27. The system of claim 21, wherein the revision processing subsystem is further configured to:
determine that the revision processing subsystem can communicate with the database system and, in response, setting a processing status to SYNCHRONIZING, the processing status stored in the revision processing subsystem;
while the processing status is set to SYNCHRONIZING, processing further requests to revise the data entity according to the aggregate offline incremental revision data and the last known value of the data entity; and
while the processing status is set to SYNCHRONIZING, transmit incremental request records stored in the revision processing subsystem to the database system in an order received by the revision processing subsystem.

28. A method for processing user requests to modify data in a database system, the method comprising:
receiving, by a revision processing subsystem, a last known value of a data entity from the database system over a first network connection;
storing, by the revision processing subsystem, the last known value in last known database values;
after receiving the last known value of the data entity from the database system, transmitting, by the revision processing subsystem, one or more further communications to the database system over the first network connection;
receiving no response, by the revision processing subsystem from the database system, to a predetermined number of the one or more further communications;
receiving, by the revision processing subsystem, an incremental revision to the data entity from a user computing device, the incremental revision to the data entity received over a second network connection; and
based on the receiving no response to the predetermined number of the one or more further communications, determining, by the revision processing subsystem, that the revision processing subsystem cannot communicate with the database system to perform the incremental revision of the data entity and, in response:
retrieving, by the revision processing subsystem, the last known value of the data entity from the last known database values;
retrieving, by the revision processing subsystem, an aggregate offline incremental revision value of the data entity from offline incremental revision data;
comparing, by the revision processing subsystem, a sum of the incremental revision and the aggregate offline incremental revision value with the last known value of the data entity;
transmitting, by the revision processing subsystem, a confirmation of the incremental revision to the user computing device when the sum of the incremental revision and the aggregate offline incremental revision value is less than or equal to the last known value of the data entity; and
transmitting, by the revision processing subsystem, a denial of the incremental revision to the user computing device when the sum of the incremental revision and the aggregate offline incremental revision value is greater than the last known value of the data entity.

29. The method of claim 28, wherein the offline incremental revision data comprises one or more records of incremental revisions received by the revision processing subsystem while the database system is unavailable to confirm the incremental revisions, wherein the method further comprises:
after transmitting a confirmation of the incremental revision, storing a record of the incremental revision in the incremental revision data.

30. The method of claim 29, wherein the method further comprises:
after storing a record of the incremental revision in the offline incremental revision data, determining, by the revision processing subsystem, that the revision processing subsystem can communicate with the database system;
transmitting, by the revision processing subsystem, the record of the incremental revision to the database system for the data entity to be revised in the database system; and
clearing, by the revision processing subsystem, the record of the incremental revision from the offline incremental revision data.

31. The method of claim 30, wherein the record of the incremental revision is one of two or more incremental revision records stored in the offline incremental revision data, wherein the method further comprises:
transmitting, by the revision processing subsystem, the incremental revisions of the two or more incremental revision records sequentially to the database system; and
clearing, by the revision processing subsystem, the two or more incremental revision records sequentially from the offline incremental revision data.

32. The method of claim 31, wherein the incremental revision is a first incremental revision of a first data entity from a first user computing device, wherein the method further comprises:
receiving, by the revision processing subsystem, a second incremental revision of a second data entity from a second user computing device, the second incremental revision received over a network;
determining, by the revision processing subsystem, that the revision processing subsystem can communicate with the database system to revise the second data entity;
determining, by the revision processing subsystem, that the offline incremental revision data includes records of one or more incremental revisions;
retrieving, by the revision processing subsystem, the last known value of the second data entity from the last known database values;
retrieving, by the revision processing subsystem, an offline incremental revision value for the second data entity from the offline incremental revision data;
comparing, by the revision processing subsystem, a sum of the second incremental revision and the offline incremental revision value for the second data entity with the last known value of the second data entity;
transmitting, by the revision processing subsystem, a confirmation of the second incremental revision to the second user when the sum of the second incremental revision and the offline incremental revision value for the second data entity is less than or equal to the last known value of the second data entity; and
transmitting, by the revision processing subsystem, a denial of the second incremental revision to the second user when the sum of the second incremental revision and the offline incremental revision value for the second data entity is greater than the last known value of the second data entity.

33. The method of claim 30, wherein the incremental revision is a first incremental revision of a first data entity received from a first user computing device, wherein the method further comprises:
receiving, by the revision processing subsystem, a second incremental revision of a second data entity from a second user computing device, the second incremental revision received over a network;
determining, by the revision processing subsystem, that the revision processing subsystem can communicate with the database system to revise the second data entity;
determining, by the revision processing subsystem, that the offline incremental revision data does not include records of any incremental revisions;
transmitting, by the revision processing subsystem, a request to the database system to revise the second data entity according to the second incremental revision;
receiving, by the revision processing subsystem, a confirmation from the database system that the second data entity is revised according to the second incremental revision; and
transmitting, by the revision processing subsystem, a confirmation of the second incremental revision to the second user computing device.

34. The method of claim 28, further comprising:
determining, by the revision processing subsystem, that the revision processing subsystem can communicate with the database system and, in response, setting a processing status to SYNCHRONIZING, the processing status stored in the revision processing subsystem;
while the processing status is set to SYNCHRONIZING, processing, by the revision processing subsystem, further requests to revise the data entity according to the aggregate offline incremental revision data and the last known value of the data entity; and
while the processing status is set to SYNCHRONIZING, transmitting, by the revision processing subsystem, incremental request records stored in the revision processing subsystem to the database system in the order received by the revision processing subsystem.

35. A method for processing user requests to modify data in a database, the method comprising:
receiving, by a revision processing subsystem, a last known value of a data entity from a database system over a first network connection;
storing, by the revision processing subsystem, the last known value of the data entity;
after receiving the last known value of the data entity from the database system, transmitting, by the revision processing subsystem, one or more first further communications to the database system over the first network connection;
receiving, by the revision processing subsystem, no response from the database system to a predetermined number of the one or more first further communications;
based on the receiving no response to the predetermined number of the one or more further communications, determining, by the revision processing subsystem, that the revision processing subsystem cannot communicate with the database system to perform revisions to the data entity;
receiving, by the revision processing subsystem, a first one or more incremental revisions to the data entity, the first incremental revisions received over one or more second network connections from first respective one or more user computing devices;
based on determining that the revision processing subsystem cannot communicate with the database system, processing the first one or more incremental revisions to the data entity according to the last known value of the data entity;
after processing the first one or more incremental revisions, transmitting, by the revision processing subsystem, a second further communication to the database system over the first network connection;
receiving a response, by the revision processing subsystem, from the database system, to the second further communication over the first network connection and, in response: synchronizing the database system with the first one or more incremental revisions; and
while synchronizing the database system with the first one or more incremental revisions, processing a second one or more incremental revisions to the data entity according to the last known value of the data entity.

36. The method of claim 35, further comprising:
after synchronizing the database system with the first one or more incremental revisions, receiving a third incremental revision to the data entity over a third network connection from a third user computing device;
processing the third incremental revision to the data entity by:
transmitting a request to revise the data entity from the revision processing subsystem to the database system; and
transmitting a confirmation for the third incremental revision to the third user computing device.

37. The method of claim 35, wherein processing the first one or more incremental revisions to the data entity according to the last known value of the data entity comprises storing one or more records representative of the first one or more incremental revisions in offline incremental revision data of the revision processing subsystem.

38. The method of claim 37, wherein synchronizing the database system with the first one or more incremental revisions comprises:
transmitting the records of the first one or more incremental revisions sequentially to the database system; and
clearing the records of the first one or more incremental revisions sequentially from the offline incremental revision data.

39. The method of claim 35, wherein processing the first one or more incremental revisions according to the last known value of the data entity comprises, for each incremental revision of the first one or more incremental revisions:
retrieving an offline incremental revision value for the data entity from offline incremental revision data of the revision processing subsystem;
comparing a sum of the incremental revision and the offline incremental revision value of the data entity with the last known value of the data entity;
transmitting a confirmation of the incremental revision to the user when the sum of the incremental revision and the offline incremental revision value of the data entity is less than or equal to the last known value of the data entity; and
transmitting a denial of the incremental revision to the user when the sum of the incremental revision and the offline incremental revision value of the data entity is greater than the last known value of the data entity.

40. The method of claim 35, wherein the one or more further communications are requests to revise the data entity.
